(19) United States
(12) Patent Application Publication
(10) Pub. No.: US 2024/0232682 A9
(43) Pub. Date: Jul. 11, 2024

(54) REINFORCEMENT LEARNING WITH MULTIPLE OBJECTIVES AND TRADEOFFS

(71) Applicant: INTERNATIONAL BUSINESS MACHINES CORPORATION, Armonk, NY (US)

(72) Inventors: Radu Marinescu, Dublin (IE); Parikshit Ram, Atlanta, GA (US); Djallel Bouneffouf, Poughkeepsie, NY (US); Tejaswini Pedapati, White Plains, NY (US); Paulito Palmes, Dublin (IE)

(21) Appl. No.: 17/972,291

(22) Filed: Oct. 24, 2022

(51) Int. Cl. G06N 20/00; G06F 7/544

(52) U.S. Cl. CPC G06N 20/00; G06F 7/5443

(57) ABSTRACT

A method for computing possibly optimal policies in reinforcement learning with multiple objectives and tradeoffs includes receiving a dataset comprising state, action, and reward information for objectives in a multiple objective environment. Tradeoff information indicating that a first vector comprising first values of the objectives in the multiple objective environment is preferred to a second vector comprising second values of the objectives in the multiple objective environment is received. A set of possibly optimal policies for the multiple objective environment is produced based on the dataset and the tradeoff information, where the set of possibly optimal policies indicates actions for an intelligent agent operating in the multiple objective environment to take.

### BACKGROUND

The present disclosure relates generally to reinforcement learning and, more particularly, to computing possibly optimal policies in reinforcement learning with multiple objectives and tradeoffs.

Reinforcement learning is an area of machine learning in artificial intelligence that may be used for controlling the actions of an intelligent agent operating in an environment. In reinforcement learning, the intelligent agent learns policies that maximize a reward function associated with an objective of the intelligent agent. For instance, the objective of the intelligent agent may be to complete a task. Actions that enable the intelligent agent to make progress towards completing the task increase the reward function. Accordingly, reinforcement learning allows the intelligent agent to select the appropriate actions to take in the environment to complete the task by maximizing the reward function.

### SUMMARY

A method for computing possibly optimal policies in reinforcement learning with multiple objectives and tradeoffs is disclosed. The method includes receiving a dataset comprising state, action, and reward information for objectives in a multiple objective environment. Tradeoff information indicating that a first vector comprising first values of the objectives in the multiple objective environment is preferred to a second vector comprising second values of the objectives in the multiple objective environment is received. A set of possibly optimal policies for the multiple objective environment is produced based on the dataset and the tradeoff information, where the set of possibly optimal policies indicates actions for an intelligent agent operating in the multiple objective environment to take.

A system for computing possibly optimal policies in reinforcement learning with multiple objectives and tradeoffs is also disclosed. The system includes a non-transitory computer-readable storage memory configured to store instructions and a processor coupled to the non-transitory computer-readable storage memory. The processor is configured to execute the instructions to cause the system to receive a dataset comprising state, action, and reward information for objectives in a multiple objective environment, receive tradeoff information indicating that a first vector comprising first values of the objectives in the multiple objective environment is preferred to a second vector comprising second values of the objectives in the multiple objective environment, and produce, based on the dataset and the tradeoff information, a set of possibly optimal policies for the multiple objective environment, where the set of possibly optimal policies indicates actions for an intelligent agent operating in the multiple objective environment to take.

A computer program product for computing possibly optimal policies in reinforcement learning with multiple objectives and tradeoffs is also disclosed. The computer program product includes instructions stored on a non-transitory computer-readable medium. When the instructions are executed by a processor, the instructions cause a system to receive a dataset comprising state, action, and reward information for objectives in a multiple objective environment, receive tradeoff information indicating that a first vector comprising first values of the objectives in the multiple objective environment is preferred to a second vector comprising second values of the objectives in the multiple objective environment, and produce, based on the dataset and the tradeoff information, a set of possibly optimal policies for the multiple objective environment, where the set of possibly optimal policies indicates actions for an intelligent agent operating in the multiple objective environment to take.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram illustration of a system for computing possibly optimal policies in reinforcement learning with multiple objectives and tradeoffs in accordance with aspects of the present disclosure.

FIG. 2 is a flowchart illustration of a method for computing possibly optimal policies in reinforcement learning with multiple objectives and tradeoffs in accordance with aspects of the present disclosure.

FIG. 3 is a block diagram illustration of a system with multiple dataset sources for computing possibly optimal policies in reinforcement learning with multiple objectives and tradeoffs in accordance with aspects of the present disclosure.

FIG. 4 is a block diagram illustration of a hardware architecture of a data processing system in accordance with aspects of the present disclosure.

The illustrated figures are only exemplary and are not intended to assert or imply any limitation with regard to the environment, architecture, design, or process in which different embodiments may be implemented.

### DETAILED DESCRIPTION

It should be understood at the outset that, although an illustrative implementation of one or more embodiments are provided below, the disclosed systems, computer program product, and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used within the written disclosure and in the claims, the terms “including” and “comprising” (and inflections thereof) are used in an open-ended fashion, and thus should be interpreted to mean “including, but not limited to.” Unless otherwise indicated, as used throughout this document, “or” does not require mutual exclusivity, and the singular forms “a,” “an,” and “the” are intended to include the plural forms as well, unless the context clearly indicates otherwise.

A “module” or “unit” (and inflections thereof) as referenced herein comprises one or more hardware or electrical components such as electrical circuitry, processors, and memory that may be specially configured to perform a particular function. The memory may comprise volatile memory or non-volatile memory that stores data such as, but not limited to, computer executable instructions, machine code, and other various forms of data. The module or unit may be configured to use the data to execute one or more instructions to perform one or more tasks. In certain instances, a module or unit may also refer to a particular set of functions, software instructions, or circuitry that is configured to perform a specific task. For example, a module or unit may comprise software components such as, but not limited to, data access objects, service components, user interface components, application programming interface (API) components; hardware components such as electrical circuitry, processors, and memory; and/or a combination thereof. As referenced herein, computer executable instructions may be in any form including, but not limited to, machine code, assembly code, and high-level programming code written in any programming language.

Also, as used herein, the term “communicate” (and inflections thereof) means to receive and/or transmit data or information over a communication link. The communication link may include both wired and wireless links, and may comprise a direct link or may comprise multiple links passing through one or more communication networks or network devices such as, but not limited to, routers, firewalls, servers, and switches. The communication networks may comprise any type of wired or wireless network. The networks may include private networks and/or public networks such as the Internet. Additionally, in some embodiments, the term communicate may also encompass internal communication between various components of a system and/or with an external input/output device such as a keyboard or display device.

In an embodiment of the present disclosure, an intelligent agent acting in an environment may have multiple objectives. In an ideal situation, the intelligent agent would be able to take actions that concurrently optimize all of the objectives. However, in a real-world situation, there may be no action that concurrently optimizes all of the objectives. For instance, an action that maximizes a first objective may have no effect or a negative effect on a second objective. In such a case, tradeoffs may be made. The tradeoffs indicate a preference amongst the different objectives. The tradeoffs may be used to select an action for the intelligent agent to take when no one action would maximize all of the objectives. However, quantifying tradeoffs and incorporating the tradeoffs in a multiple objective reinforcement learning environment may be difficult. For instance, a user may not be able to precisely quantify a preference amongst the multiple objectives. Accordingly, embodiments of the present disclosure provide methods and systems that allow a user to incorporate imprecise tradeoff preferences in reinforcement learning. For instance, in one embodiment, a user is presented with multiple different potential sets of results having different values for the different objectives. The user can select one or more of the sets of results that are preferable without knowing a precise relationship amongst the objectives. The user selection may be used as tradeoff information that is incorporated into calculating policies for the intelligent agent to determine actions to take in the multiple objective environment.

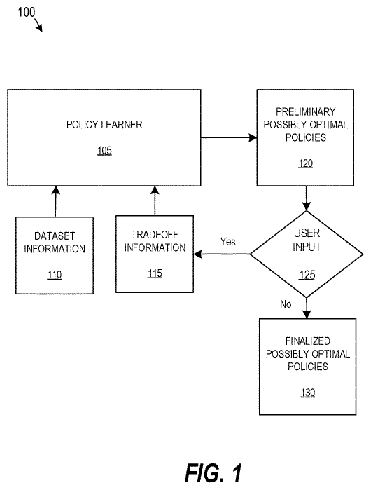

FIG. 1 is a block diagram illustration of a system 100 for computing possibly optimal policies in reinforcement learning with multiple objectives and tradeoffs. The system 100 includes a policy learner 105, dataset information 110, tradeoff information 115, preliminary possibly optimal policies 120, user input 125, and finalized possibly optimal policies 130.

The dataset information 110 includes datasets for a multiple objective operating environment. Each dataset may be of the form of Equation 1.

dataset=(s,a,r,s′). Equation 1

In Equation 1, “s” is a state, “a” is an action, “r” is a reward vector, and “s′” is a next state. When an intelligent agent in the multiple objective operating environment performs the action “a” while in the state “s,” the intelligent agent transitions to the next state “s′” that corresponds to the reward vector “r.” Each reward vector “r” may be of the form of Equation 2.

r=(r₁, . . . rₖ) Equation 2

In Equation 2, “r” is a value of a reward, and “k” is an index corresponding to the number of objectives in the multiple objective operating environment. For instance, if a multiple objective operating environment has five objectives, the reward vector has five reward values r₁, r₂, r₃, r₄, and r₅, where each reward value corresponds to one of the objectives. Each reward value may be calculated using a reward function and represents progress towards the objective. In one embodiment, a reward value having a greater value represents progressing towards the corresponding objective better than a reward value have a lesser value.

The tradeoff information 115 includes one or more sets of values of the objectives from the multiple objective operating environment and relationship information describing a preference between the one or more sets of values. The tradeoff information 115 may be of the form of Equation 3.

(u>v) Equation 3

In Equation 3, “u” and “v” are dimensional vectors of values of the objectives from the multiple objective operating environment. In a multiple objective environment having k objectives, each of the dimensional vectors has a value for each of the k objectives. The “>” greater than symbol is relationship information indicating that the “u” dimensional vector is preferred to the “v” dimensional vector. For example, in a multiple objective environment having two objectives, an example of tradeoff information 115 is “((1, 0)>(0, 1.5)).” This tradeoff information indicates that 1 unit of the first objective is preferred to one and a half units of the second objective. Another example of tradeoff information 115 is ((0, 1)<(2, 0)).” This tradeoff information indicates that two units of the first objective is preferred to one unit of the second objective. Embodiments of the present disclosure are not however limited to any particular form of the tradeoff information 115 and may include any tradeoff information 115 that indicates a preference amongst objectives.

The policy learner 105 receives the dataset information 110 and the tradeoff information 115 and calculates preliminary possibly optimal policies 120. Each of the preliminary possibly optimal policies 120 may be of the form of Equation 4.

P=π(s) Equation 4

In Equation 4, “P” is a policy, “π” is a policy function, and “s” is a state. The policy “P” indicates an action to take when the intelligent agent is at the state “s.” Each policy “P” has a corresponding return vector. Each return vector may be of the form of Equation 5.

u=(u₁, . . . uₖ) Equation 5

In Equation 5, “u” is a return vector, “u₁” is a return value with respect to a first objective in a multiple objective environment, and “uₖ” is a return value with respect to a “k” objective in the multiple objective environment. The return vector “u” includes a return value for each objective in the multiple objective environment. For instance, if a multiple objective operating environment has five objectives, the return vector has five return values u₁, u₂, u₃, u₄, and u₅, where each return value corresponds to one of the objectives.

The policy learner 105 calculates whether a policy is a preliminary possibly optimal policy 120 when the policy satisfies the tradeoff information 115 for any condition. Each condition may be represented by a weight vector of the form of Equation 6.

w=(w₁, . . . wₖ) Equation 6

In Equation 6, “w” is a weight vector, “w₁” is a weight value with respect to a first objective in a multiple objective environment, “wₖ” is a weight value with respect to a “k” objective in the multiple objective environment. The weight vector “w” includes a weight value for each objective in the multiple objective environment. For instance, if a multiple objective operating environment has five objectives, the weight vector has five weight values w₁, w₂, w₃, w₄, and w₅, where each weight value corresponds to one of the objectives. A sum of the weight values for each weight vector is one. The sum of the weight values may be represented by Equation 7.

Σᵢ₌₁^{k}wₖ=1 Equation 7

In Equation 7, “k” is a number of objectives in the multiple objective environment, and “w” is a weight value of an objective. Additionally, it should be noted that although the sum of the weight values is known to be one, the actual weight values may not be known. In such a case, embodiments of the present disclosure are still able to calculate the preliminary possibly optimal policies 120 without knowing any of the specific weight values for any of the objectives.

The policy learner 105 calculates that a policy satisfies the tradeoff information 115 when a scalar product of any weight vector and a return vector for the policy satisfy a tradeoff condition. For instance, if a weight vector is “w” and a tradeoff condition is “(u>v),” the policy satisfies the tradeoff condition when the scalar product of “w” and “u” is greater than or equal to the scalar product of “w” and “v.” Examples of scalar product calculations are shown in Equations 8, 9, and 10.

w·u≥w·v Equation 8

w·u=w₁*u₁+ . . . +wₖ·uₖ Equation 9

w·v=w₁*v₁+ . . . +wₖ·vₖ Equation 10

In Equations 8, 9, and 10, “w” is a weight vector, “u” and “v” are dimensional vectors, and “k” is an index corresponding to the number of objectives in the multiple objective operating environment.

After the policy learner 105 calculates that one or more of the policies satisfy the tradeoff condition for any scenario, the policy learner 105 outputs the one or more policies as the preliminary possibly optimal policies 120. The preliminary possibly optimal policies 120 may be of the form of Equation 11.

P={P₁, . . . Pₙ} Equation 11

In Equation 11, “P” is a set of preliminary possibly optimal policies, “n” represents a number of polices that are calculated to be possibly optimal, “P₁” is a first possibly optimal policy, and “Pₙ” is a last or n^{th} possibly optimal policy in the “n” number of possibly optimal policies. The set of preliminary possibly optimal policies has an associated return vector. The return vector may be of the form of Equation 12.

uⁱ=(u₁, . . . uₖ) Equation 12

In Equation 12, “uⁱ” is a return vector, “i” is an index corresponding to the number of policies in the set of preliminary possibly optimal policies, “u₁” is a return value with respect to a first objective in a multiple objective environment, and “uₖ” is a return value with respect to a “k” objective in the multiple objective environment. Accordingly, the return vector includes return values for each objective for each policy in the set of preliminary possibly optimal policies.

After the preliminary possibly optimal policies 120 are calculated, user input 125 may optionally be collected. In one embodiment, a user may be presented with one or more return values corresponding to the preliminary possibly optimal policies. Then, the user may provide an indication of a preference about the one or more return values. For instance, the user may select or input one or more return values that are preferred and/or one or more other return values that are not preferred. The user input 125 is then fed back to the tradeoff information 115 and is used as additional tradeoff information to recalculate the preliminary possibly optimal policies 120. This process may be iteratively performed to continue calculating revised preliminary possibly optimal policies 120 until the preliminary possibly optimal policies 120 meet the user's requirements. Once the user's requirements are met, the user input 125 can stop being collected, and the finalized possibly optimal policies 130 are output. The finalized possibly optimal policies 130 may be used by an intelligent agent in an artificial intelligence implementation. In another embodiment, the user input 125 may not be collected. In such a case, the preliminary possibly optimal policies 120 may be output as the finalized possibly optimal policies 130.

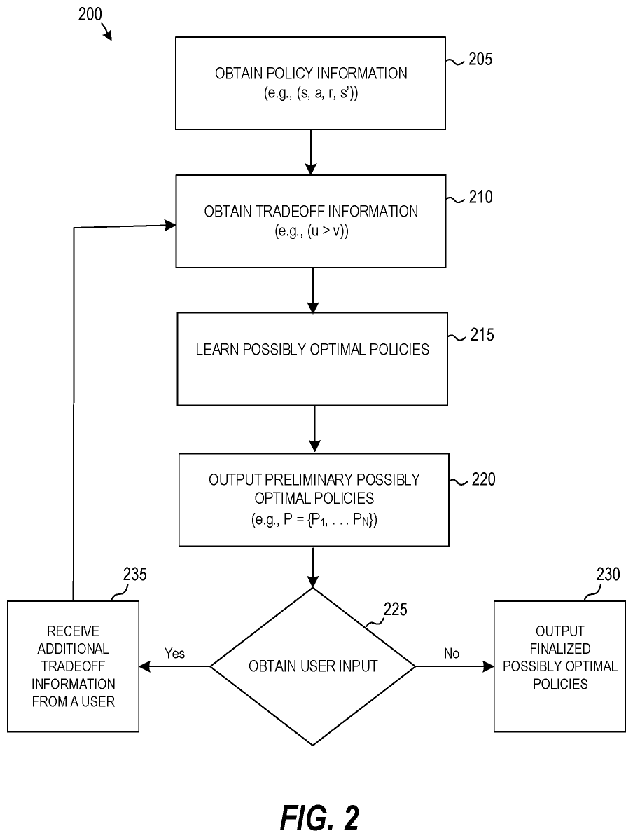

FIG. 2 is a flowchart illustration of a method 200 for computing possibly optimal policies in reinforcement learning with multiple objectives and tradeoffs. At step 205, dataset information is obtained. The dataset information may be of the form “(s, a, r, s′),” where “s” is a state, “a” is an action, “r” is a reward vector, and “s′” is a next state. At step 210, tradeoff information is obtained. The tradeoff information may be of the form “(u>v),” where “u” and “v” are dimensional vectors of values of objectives, and where the “>” greater than symbol is relationship information indicating that the “u” dimensional vector is preferred to the “v” dimensional vector. At step 215, possibly optimal policies are learned using the dataset information and the tradeoff information. At step 220, preliminary possibly optimal policies are output. The preliminary possibly optimal policies may be of the form “P={P₁, . . . Pₙ},” where “P” is a set of preliminary possibly optimal policies, “n” represents a number of polices that are calculated to be possibly optimal, “P₁” is a first possibly optimal policy, and “Pₙ” is a last or n^{h} possibly optimal policy in the “n” number of possibly optimal policies. At step 225, a determination is made whether user input is obtained. If user input is not obtained, the method 200 continues to step 230. At step 230, the preliminary possibly optimal policies from step 220 are output as the finalized possibly optimal policies. If user input is obtained, the method 200 continues to step 235. At step 235, additional tradeoff information is obtained from a user. For instance, a user may be presented with one or more return values corresponding to the preliminary possibly optimal policies. Then, the user may provide an indication of a preference about the one or more return values. The user input is then fed back and is used as additional tradeoff information to recalculate the preliminary possibly optimal policies. The steps 210, 215, 220, 225, and 235 may be iteratively performed to continue calculating revised preliminary possibly optimal policies until the preliminary possibly optimal policies meet the user's requirements. Once the user's requirements are met, the user input can stop being collected, and the finalized possibly optimal policies are output at step 230.

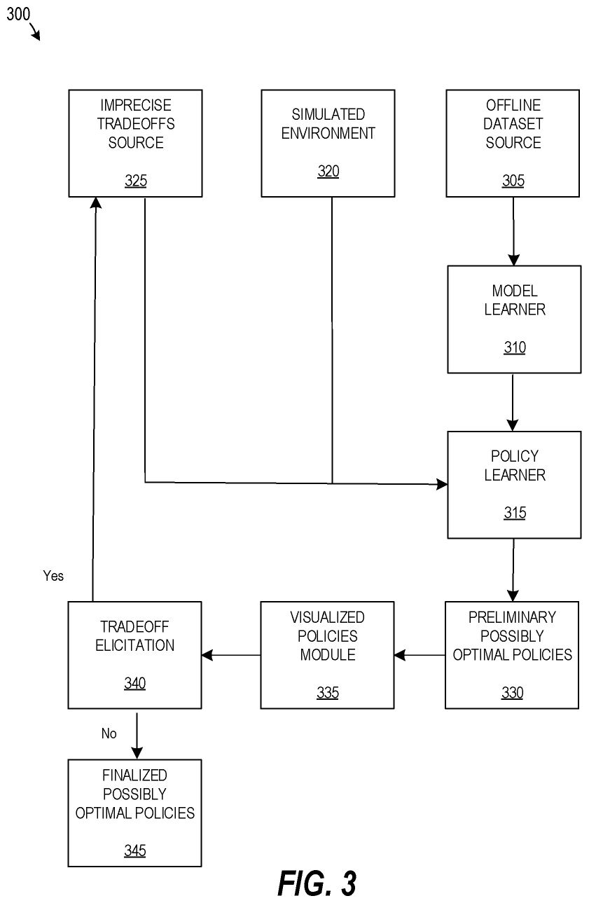

FIG. 3 is a block diagram illustration of a system 300 with multiple dataset sources for computing possibly optimal policies in reinforcement learning with multiple objectives and tradeoffs. The system 300 includes an offline dataset source 305, a model learner 310, a policy learner 315, a simulated environment 320, an imprecise tradeoff source 325, preliminary possibly optimal policies 330, visualized policies module 335, tradeoff elicitation 340, and finalized possibly optimal policies 345.

The offline dataset source 305 includes datasets of the form “(s, a, r, s′),” where “s” is a state, “a” is an action, “r” is a reward vector, and “s′” is a next state. The datasets may be from previous observations of the multiple objective environment and may be stored in the offline dataset source 305, which may be a database or other storage device.

The model learner 310 is optional and may be included in embodiments that use model-based reinforced learning. The model learner 310 receives an offline dataset (e.g., from offline dataset source 305) that is in the form of “(s, a, r, s′).” The model learner 310 outputs a reward model and a transition model. The reward model may be of the form of Equation 13.

reward model=r(s,a) Equation 13

In Equation 13, the reward model calculates a reward “r” based on a given state “s” and action “a.” The reward model may be generated using any method. In one embodiment, the reward model is generated using a regression task in an automated machine learning pipeline. The transition model may be of the form of Equation 14.

transition model=T(s′|s,a) Equation 14

In Equation 14, the transition model calculates a next state “s′” based on a given state “s” and an action “a.” The transition model may be generated using any method. In one embodiment, the transition model is generated using a density estimator such as a sum-products network.

The policy learner 315 receives dataset information and tradeoff information and calculates preliminary possibly optimal policies 330. The dataset information may be received from the offline dataset source 305 and the model learner 310 and/or from the simulated environment 320 that generates simulated dataset information. The tradeoff information may be received from the imprecise tradeoff source 325 and/or from a user.

The policy learner 315 may calculate possibly optimal policies using a value function-based multiple objective reinforcement algorithm. In one embodiment, possibly optimal policies are calculated using a multi-objective fitted Q-iteration (MOFQI) algorithm. The MOFQI algorithm may be of the form of Equation 15.

Q′(s,α)=r(s,α)+γ max_{α}Q(s,α) Equation 15

In Equation 15, “Q′(s, a)” is a Q-target for a state “s” and an action “a,” “r(s, a)” is a reward value for the state “s” and the action “a,” “γ” is a discount factor, and “max_{α}Q(s, α)” is a maximum value of Q for all possible actions in the next state. The discount factor “γ” quantifies how much weight is given for future rewards and is between 0 and 1. When the discount factor “γ” is closer to 0, more emphasis is given to immediate rewards. When the discount factor “γ” is closer to 1, more emphasis is given to future rewards. After Q-targets are calculated, a reward vector for a given Q-target is checked to determine if it is optimal for any condition (e.g., for any set of weighting factors given by Equation 7). In one embodiment, the reward vector for a given Q-target is compared to another reward vector using the inequality of the form of Equation 16.

w₁*u₁+ . . . +wₖ*uₖ≥w₁*v₁+ . . . +wₖ*vₖ Equation 16

In Equation 16, “w₁ . . . wₖ” is a set of weights, “u₁ . . . uₖ” is a reward vector for a given Q-target, and “v₁ . . . vₖ” is another reward vector. A policy is calculated to be a preliminary possibly optimal policy 330 when the inequality of Equation 16 is true for its reward vector for at least one set of weights.

After the preliminary possibly optimal policies 330 are calculated, an optional visualized policies module 335 may be used. The visualized policies module 335 receives an input of a set of policies (e.g., Equation 11: P={P₁, . . . Pₙ}). Each of the policies is associated with a return vector (e.g., Equation 5: u=(u₁, . . . uₖ)). In one embodiment, a user is presented with an option to select one or more preferred return vectors. For instance, the visualized policies module 335 may present the user with a return vector “u₁” associated with a policy “P₁” and a return vector “uⱼ” associated with a policy “Pⱼ.” The user may select one of the return vectors that is preferred (e.g., the return vector “uᵢ” is preferred to “uⱼ” or “(uᵢ>uⱼ)”). This information may be used as additional tradeoff information to further select possibly optimal policies in a next iteration. This process of receiving user input to produce additional tradeoff information may be continued as required.

At tradeoff elicitation block 340, a determination is made whether tradeoff information has been elicited from a user. If no tradeoff information is elicited, the preliminary possibly optimal policies 330 are output as the finalized possibly optimal policies 345. If tradeoff information is elicited, the tradeoff information is added to the imprecise tradeoff source 325 and is used in a next iteration of selecting possibly optimal policies.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

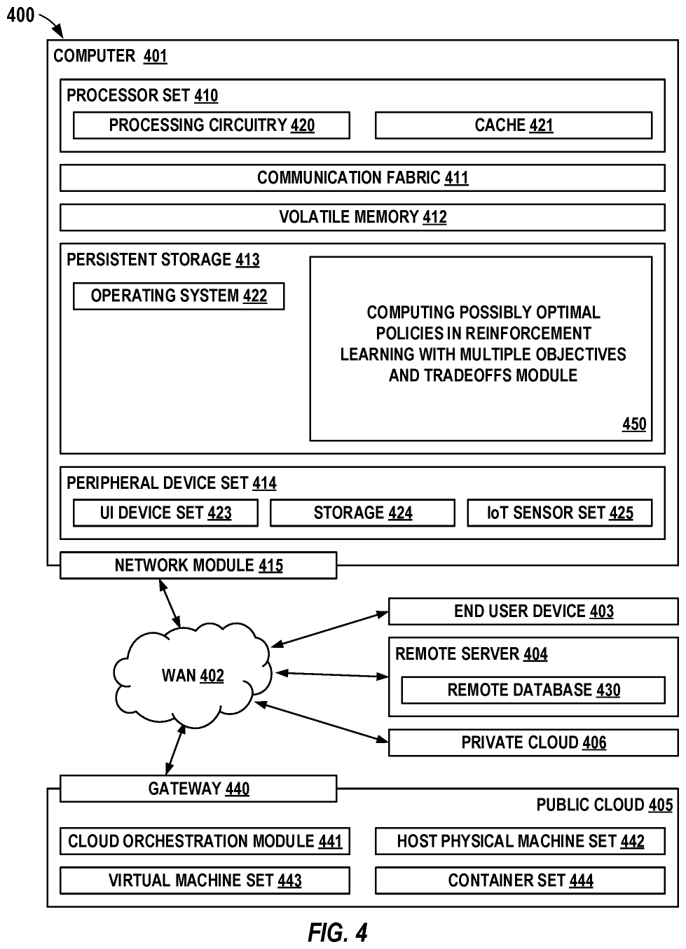

FIG. 4 is a block diagram illustration of a hardware architecture of a computing environment 400 in accordance with aspects of the present disclosure. Computing environment 400 contains an example of an environment for the execution of at least some of the computer code involved in performing the inventive methods, such as computing possibly optimal policies in reinforcement learning with multiple objectives and tradeoffs module 450. In addition to module 450, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and module 450, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in module 450 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in module 450 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, user interface (UI) device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. Internet of Things (IoT) sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441.

The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations ofVCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, central processing unit (CPU) power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. Further, the steps of the methods described herein may be carried out in any suitable order, or simultaneously where appropriate. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving a dataset comprising state, action, and reward information for objectives in a multiple objective environment;
receiving tradeoff information indicating that a first vector comprising first values of the objectives in the multiple objective environment is preferred to a second vector comprising second values of the objectives in the multiple objective environment; and
producing, based on the dataset and the tradeoff information, a set of possibly optimal policies for the multiple objective environment, wherein the set of possibly optimal policies indicates actions for an intelligent agent operating in the multiple objective environment to take.

2. The method of claim 1, wherein receiving the dataset comprises receiving the dataset from an offline dataset source.

3. The method of claim 1, wherein receiving the dataset comprises receiving the dataset from a simulated environment.

4. The method of claim 1, wherein receiving the tradeoff information comprises receiving the tradeoff information from a user.

5. The method of claim 1, wherein producing the set of possibly optimal policies comprises iteratively receiving additional tradeoff information from a user and calculating a refined set of possibly optimal polices based on the additional tradeoff information.

6. The method of claim 1, wherein producing the set of possibly optimal policies comprises:
comparing, using weighting values corresponding to different conditions, the first vector and the second vector by calculating a first sum of products of the weighting values and first objective values of the first vector and a second sum of products of the weighting values and second objective values of the second vector; and
adding a first possibly optimal policy corresponding to the first vector to the set of possibly optimal policies when the first sum is greater than the second sum for any of the weighting values.

7. The method of claim 1, further comprising:
visually presenting tradeoff options to a user;
receiving a selection of one of the tradeoff options; and
refining, based on the selection, the set of possibly optimal policies.

8. A system, comprising:
a non-transitory computer-readable storage memory configured to store instructions; and
a processor coupled to the non-transitory computer-readable storage memory and configured to execute the instructions to cause the system to:
receive a dataset comprising state, action, and reward information for objectives in a multiple objective environment;
receive tradeoff information indicating that a first vector comprising first values of the objectives in the multiple objective environment is preferred to a second vector comprising second values of the objectives in the multiple objective environment; and
produce, based on the dataset and the tradeoff information, a set of possibly optimal policies for the multiple objective environment, wherein the set of possibly optimal policies indicates actions for an intelligent agent operating in the multiple objective environment to take.

9. The system of claim 8, wherein the processor is further configured to execute the instructions to receive the dataset by receiving the dataset from an offline dataset source.

10. The system of claim 8, wherein the processor is further configured to execute the instructions to receive the dataset by receiving the dataset from a simulated environment.

11. The system of claim 8, wherein the processor is further configured to execute the instructions to receive the tradeoff information by receiving the tradeoff information from a user.

12. The system of claim 8, wherein the processor is further configured to execute the instructions to produce the set of possibly optimal policies by iteratively receiving additional tradeoff information from a user and calculating a refined set of possibly optimal polices based on the additional tradeoff information.

13. The system of claim 8, wherein the processor is further configured to execute the instructions to produce the set of possibly optimal policies by:
comparing, using weighting values corresponding to different conditions, the first vector and the second vector by calculating a first sum of products of the weighting values and first objective values of the first vector and a second sum of products of the weighting values and second objective values of the second vector; and
adding a first possibly optimal policy corresponding to the first vector to the set of possibly optimal policies when the first sum is greater than the second sum for any of the weighting values.

14. The system of claim 8, wherein the processor is further configured to execute the instructions to:
visually present tradeoff options to a user;
receive a selection of one of the tradeoff options; and
refine, based on the selection, the set of possibly optimal policies.

15. A computer program product comprising instructions stored on a non-transitory computer-readable medium that, when executed by a processor, cause a system to:
receive a dataset comprising state, action, and reward information for objectives in a multiple objective environment;
receive tradeoff information indicating that a first vector comprising first values of the objectives in the multiple objective environment is preferred to a second vector comprising second values of the objectives in the multiple objective environment; and
produce, based on the dataset and the tradeoff information, a set of possibly optimal policies for the multiple objective environment, wherein the set of possibly optimal policies indicates actions for an intelligent agent operating in the multiple objective environment to take.

16. The computer program product of claim 15, wherein the instructions further cause the system to receive the dataset by receiving the dataset from an offline dataset source.

17. The computer program product of claim 15, wherein the instructions further cause the system to receive the dataset by receiving the dataset from a simulated environment.

18. The computer program product of claim 15, wherein the instructions further cause the system to receive the tradeoff information by receiving the tradeoff information from a user.

19. The computer program product of claim 15, wherein the instructions further cause the system to produce the set of possibly optimal policies by iteratively receiving additional tradeoff information from a user and calculating a refined set of possibly optimal polices based on the additional tradeoff information.

20. The computer program product of claim 15, wherein the instructions further cause the system to produce the set of possibly optimal policies by:
comparing, using weighting values corresponding to different conditions, the first vector and the second vector by calculating a first sum of products of the weighting values and first objective values of the first vector and a second sum of products of the weighting values and second objective values of the second vector; and
adding a first possibly optimal policy corresponding to the first vector to the set of possibly optimal policies when the first sum is greater than the second sum for any of the weighting values.
